(19) United States
(12) Patent Application Publication
(10) Pub. No.: US 2022/0325814 A1
(43) Pub. Date: Oct. 13, 2022

(54) A VALVE

(71) Applicant: Reliance Worldwide Corporation (Aust.) Pty. Ltd., Queensland (AU)

(72) Inventors: Gary HAY, Queensland (AU); Jake HARDT, Queensland (AU)

(21) Appl. No.: 17/761,623

(22) PCT Filed: Sep. 25, 2020
(86) PCT No.: PCT/AU2020/051024

§ 371 Date: Mar. 18, 2022

(30) Foreign Application Priority Data
Sep. 26, 2019 (AU) 2019903629

(51) Int. Cl. F16K 31/00; F16K 11/044; F24H 9/20

(52) U.S. Cl. CPC F16K 31/002; F16K 11/044; F24H 9/2007

(57) ABSTRACT

A valve including: a body having: a first aperture; a second aperture; a first channel in fluid communication with the first aperture; a second channel in fluid communication with at least part of the second aperture; and an outlet aperture; an adjusting portion associated with the body, the adjusting portion providing a stop; a piston in fluid communication with the first channel, the second channel and the outlet aperture; a thermostatic element configured to assist with moving the piston in response to engaging with the stop, the piston being configured to regulate fluid flow from the first channel and the second channel to the outlet; and a return spring configured to assist with biasing the thermostatic element, wherein part of the fluid flow entering the first channel flows along the piston and exits from a portion of the second aperture.

### RELATED APPLICATION

This application is based on and claims priority to Australian provisional patent application No 2019903629 filed on 26 Sep. 2019, the content of which is incorporated by reference in its entirety.

### FIELD OF THE INVENTION

The invention relates to a valve. In particular, the invention relates, but is not limited, to a valve for a hot water system. The invention also relates to a water heater as well as a method associated with the valve.

### BACKGROUND TO THE INVENTION

Reference to background art herein is not to be construed as an admission that such art constitutes common general knowledge in Australia or elsewhere.

In a hot water system, cold water is typically heated in a tank or a tube to a temperature that is controlled by a thermostat. Normally, water is heated to a temperature that is high enough to eliminate a number of bacteria including Legionella. As heated water is drawn from the tank or tube, to an end user, further cold water is drawn into the system for heating. Thermostatic mixing valves may be located downstream of the hot water system to allow the heated water to mix with cold water to avoid scalding.

In the past, attempts have been made to attempt to incorporate thermostatic mixing valves into hot water systems but this has resulted in complex arrangements being implemented. These complex arrangements are difficult to manufacture and, in the case of providing convoluted flow paths, increases the pressure drop across the valves. In addition, connecting the valves to the hot water systems can be difficult, particularly when a cold water tank inlet is incorporated into the valve.

The present inventors have developed an improved valve.

### SUMMARY OF INVENTION

In one form, the invention resides in a valve including:

a body having:
a first aperture;
a second aperture;
a first channel in fluid communication with the first aperture;
a second channel in fluid communication with at least part of the second aperture; and
an outlet aperture;

an adjusting portion associated with the body, the adjusting portion providing a stop;

a piston in fluid communication with the first channel, the second channel and the outlet aperture;

a thermostatic element configured to assist with moving the piston in response to engaging with the stop, the piston being configured to regulate fluid flow from the first channel and the second channel to the outlet; and

a return spring configured to assist with biasing the thermostatic element,

wherein part of the fluid flow entering the first channel flows along the piston and exits from a portion of the second aperture.

In an embodiment, a connection fitting is connected to the first channel, the connection fitting being configured to connect to a tube.

In an embodiment, the second aperture allows fluid to flow into the second channel in one direction whilst fluid flow exiting the portion of the second aperture, from the first channel, is in another direction.

In an embodiment, flow through the first channel substantially aligns with flow through the connection fitting.

In an embodiment, the part of the fluid following along the piston and exiting the second aperture flows in a substantially linear direction from the first channel to at or near the second aperture.

In an embodiment, the part of the fluid following along the piston and exiting the second aperture flows from one side of the body to another side of the body.

In an embodiment, the part of the fluid flow flowing along the piston involves the fluid flow moving over and/or interacting with a surface of the piston.

In an embodiment, the first channel extends at least partway around a perimeter of the piston to allow fluid to pass along the piston.

In an embodiment, the first channel extends from one side of the piston to another side.

In an embodiment, the first channel extends substantially linearly across the body.

In an embodiment, the first channel extends substantially around one end of the piston.

In an embodiment, the fluid flow along the second channel, within the body, avoids mixing with the fluid flow passing the second aperture from the first channel.

In an embodiment, the connection fitting is configured to connect to a tube by sliding the tube into engagement with the connection fitting.

In an embodiment, the tube slides substantially in a linear direction to connect to the connection fitting.

In an embodiment, the connection fitting is a crimped fitting.

In an embodiment, the connection fitting includes one or more barbs.

In an embodiment, at least part of the connection fitting is surrounded by part of the body in the form of a valve body.

In an embodiment, the connection fitting is configured to connect a tube and maintain a connection therewith whilst hot water from a water heater passes thereover.

In an embodiment, a sleeve assists in connecting the tube to the connection fitting. In an embodiment, the sleeve is crimped onto the tube to assist in securing the connection between the tube and the connection fitting.

In an embodiment, the connection fitting includes a connecting part that is configured to connect to a connecting portion that is formed in the first channel. In an embodiment, the connecting part threadingly engages with the connecting portion.

In an embodiment, at least part of the connection fitting is surrounded by part of the body in the form of an adapter.

In an embodiment, the adapter is configured to connect to a water heater.

In an embodiment, a dividing portion separates the first channel from the second channel.

In an embodiment, the dividing portion extends along a middle portion of the piston.

In an embodiment, the dividing portion includes a sealing portion that assists in providing a seal with the piston in order to fluidly separate the first channel from the second channel.

In an embodiment, the first channel extends along one side of the piston whilst the second channel extends along an opposite side of the piston.

In an embodiment, moving an adjusting member of the adjusting portion relocates the stop in order to change a predetermined outlet temperature.

In an embodiment, the adjusting portion includes an aperture to receive a driving tool to adjust the position of the stop.

In a further form, the invention resides in a method of controlling fluid flow through a valve for a water heater, the method including:

flowing fluid through a first aperture;

flowing fluid through at least part of a second aperture; and

adjusting a piston such that fluid from the first aperture and the second aperture is mixed in a way to reach a predetermined temperature as it exits an outlet aperture,

wherein part of the fluid entering the first aperture is directed to flow in contact around the piston in order to be directed out of a portion of the second aperture.

In an embodiment, the step of flowing fluid through the first aperture includes flowing fluid through a first channel.

In an embodiment, the step of flowing fluid through at least part of the second aperture includes flowing fluid through a second channel.

In an embodiment, the method further includes connecting a connection fitting to a tube, the connection fitting being in fluid communication with the first aperture.

In an embodiment, the step of connecting the connection fitting to the tube includes pushing the tube into connection with the connection fitting. In an embodiment, the tube is pushed in a substantially linear direction.

In an embodiment, the step of pushing the tube into connection with the connection fitting includes moving the tube over one or more barbs.

In an embodiment, the step of directing fluid flow out of the portion of the second aperture includes flowing the fluid along the connection fitting with the tube to the water heater.

In an embodiment, the method further includes connecting an adapter to a water heater.

In an embodiment, the step of flowing fluid through the first channel includes flowing fluid from one side of the piston, to another side of the piston, in order to allow fluid to be directed out of the portion of the second aperture.

In an embodiment, the step of flowing fluid through the second channel includes flowing the fluid past the piston, in order to be directed out of the portion of the second aperture, in a different direction.

In another form, the invention resides in a kit including:

a body having:
a first aperture;
a second aperture;
a first channel in fluid communication with the first aperture;
a second channel in fluid communication with at least part of the second aperture; and
an outlet aperture, wherein part of the fluid flow entering the first channel flows along a piston and exits from a portion of the second aperture; and

at least one of:

an adjusting portion associated with the body, the adjusting portion providing a stop;

the piston in fluid communication with the first channel, the second channel and the outlet aperture;

a thermostatic element configured to assist with moving the piston in response to engaging with the stop, the piston being configured to regulate fluid flow from the first channel and the second channel to the outlet; or

a return spring configured to assist with biasing the thermostatic element.

In an embodiment, a connection fitting in the form of a crimped fitting is connected to the first channel.

In an embodiment, a connection fitting is fitted to the first channel such that the connection fitting is configured to slide into a sealing engagement with a tube.

In an embodiment, the body includes an adapter that is configured to connect to a water heater.

As will be understood from this specification, the invention provides a valve and method which addresses at least in part one or more of the disadvantages or problems noted above or at least provides a useful alternative.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of a valve, according to an embodiment of the invention;

FIG. 2 illustrates a cross sectional view of the valve in FIG. 1;

FIG. 3 illustrates a cross sectional view of the valve, in FIG. 1, connected to a tank of a hot water system according to an embodiment of the invention; and

FIG. 4 illustrates a close up view of the water system shown in FIG. 3.

### DETAILED DESCRIPTION

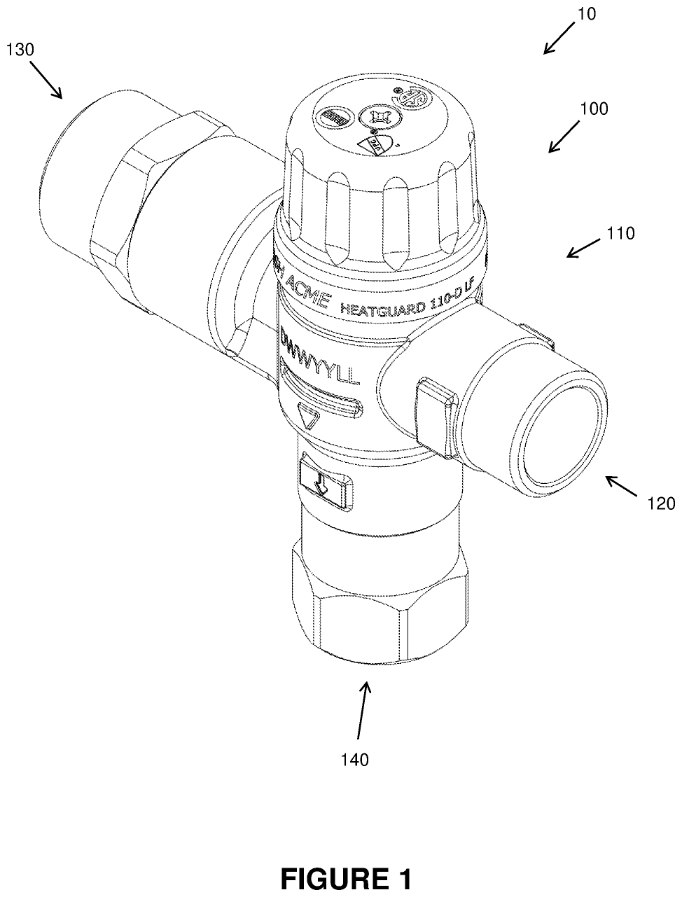

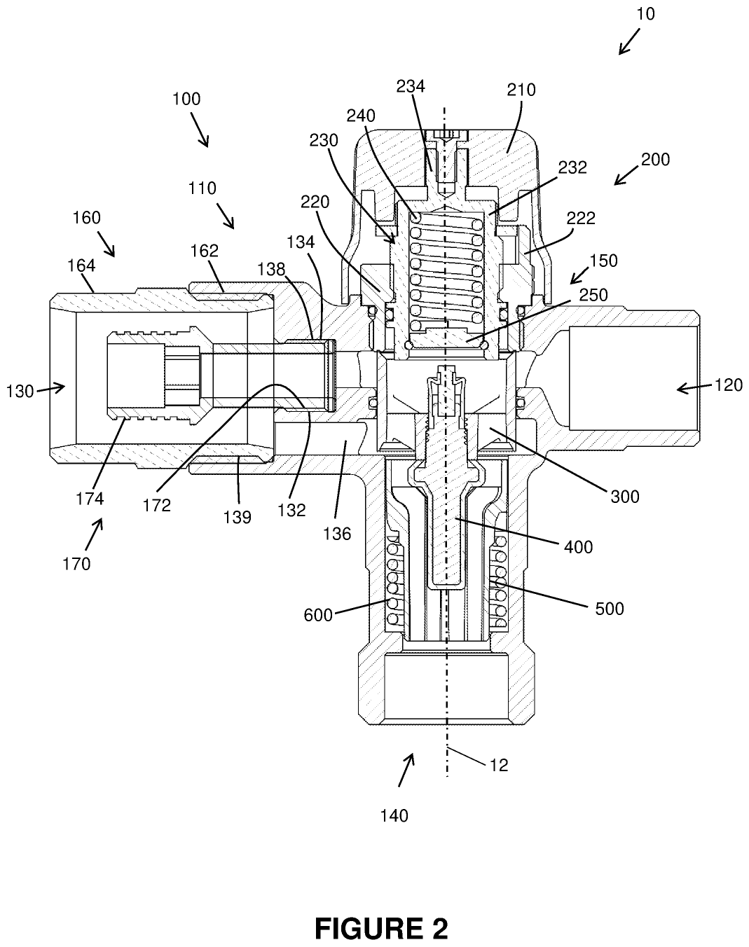

FIGS. 1 and 2 illustrate a valve 10 according to an embodiment of the invention. The valve 10 includes a body 100, an adjusting portion 200, a piston 300, a thermostatic element 400, a supporting member 500 and a return spring 600. It will be appreciated that the valve 10 may be provided in a kit for assembly where, for example, the body 100 is provided with one or more of the other components of the valve 10.

The body 100 includes a valve body 110, an adapter 160 and a connection fitting 170. The valve body 110 includes a first aperture 120, a second aperture 130, an outlet aperture 140 and a connecting aperture 150. The first aperture 120 is configured to receive relatively cold water therethrough. The first aperture 120 is substantially circular and tapers towards the piston 300. The first aperture 120 is configured to provide water past a first end of the piston 300 (towards the outlet aperture 140) and, as further outlined below, water is also provided towards the second aperture 130. The first aperture 120 is axially aligned with the second aperture 130. That is, the first aperture 120 is substantially concentric with the second aperture 130.

In a similar manner to the first aperture 120, the second aperture 130 is substantially circular. At least a part of the second aperture 130 is configured to receive relatively hot water from a hot water system. As further outlined below, the second aperture 130 interacts with the adapter 160 and the connection fitting 170. The second aperture 130 is associated with a dividing portion 132. The dividing portion 132 assist in defining a first channel 134 and a second channel 136. That is, the first channel 134 and the second channel 136 is formed between the dividing portion 132 and an outer portion of the valve body 110 (along with the piston 300).

The first channel 134 extends substantially between the first aperture 120 and the second aperture 130. In particular, the first channel 134 extends (circularly) around the first end of the piston 300 to fluidly connect the first aperture 120 to a portion of the second aperture 130. The first channel 134 is defined by at least two conduits that extend around the piston 300. These conduits therefore substantially form a semi-circle around the piston 300. By providing the first aperture 120 to be fluidly connected to a portion of the second aperture 130, via the first channel 134, allows cold water to be delivered to the hot water system. In this regard, hot water passes in one direction through the second aperture 130, to the second channel 136, whilst cold water passes out another direction of the second aperture 130. This avoids the need to have a separate cold water inlet into the hot water system.

The second channel 136 is configured to provide water past a second end of the piston 300 towards the outlet aperture 140. In a similar manner to the first channel 134, the second channel 136 extends around the circumference of the piston 300. This allows the second channel 136 to provide hot water past the second end of the piston 300 towards the outlet aperture 140. Adjacent the piston 300, the second channel 136 is fluidly sealed from the first channel 134. In particular, the dividing portion 132 assists in providing a seal that seals against the piston 300 in order to assist in fluidly isolating the first channel 134 from the second channel 136. The second channel 136 is, to an extent, sealed from the first aperture 120 but they are in fluid communication via the piston 300.

The second aperture 130 is configured to receive the adapter 160. In particular, the fastening portion 139 of the aperture 130 is configured to connect to a body connecting portion 162 of the adapter 160. The body connecting portion 162 includes a thread in this embodiment. The adapter 160 also includes a tank connection portion 164 that, as further outlined below, is configured to connect to a water tank of a water heater.

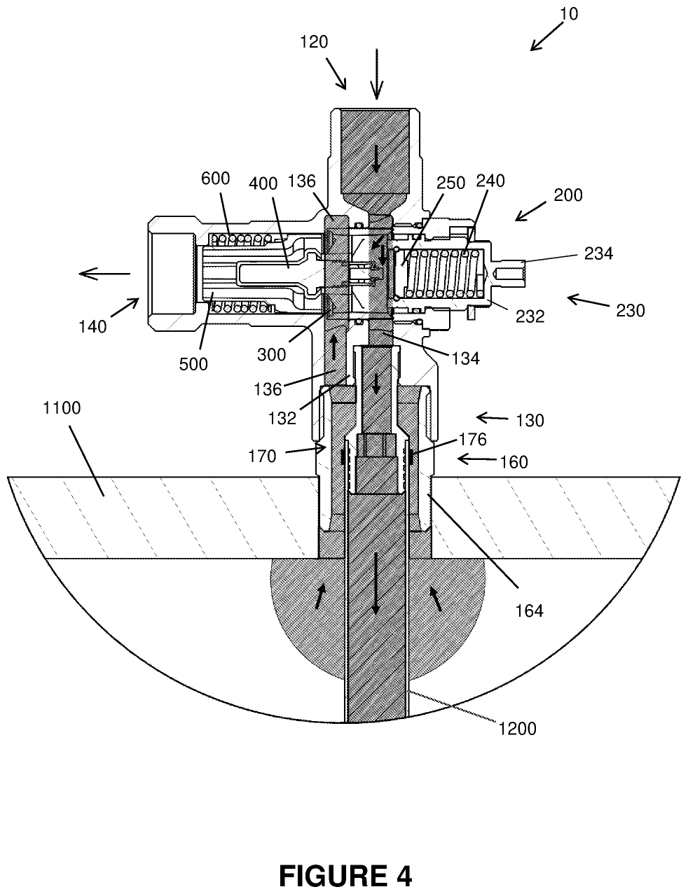

The connection fitting 170 is substantially circular. The connection fitting 170 sits substantially concentric within the second aperture 130. The connection fitting 170 includes an attaching part 172 and a connecting part 174. The connecting part 172 is configured to connect to a connecting portion 138 that is formed in the first channel 134. This assists in providing a flow path to the water heater. In this regard, the connecting part 174 in this embodiment is in the form of a barbed connection. The barbed connection is configured to be connected to a pipe extending from the water heater. This allows the water heater to be connected to a cold fluid source. The barbed connection includes a plurality of protrusions that assist in retaining the pipe extending from the water heater. Once the tank connection portion 164 is connect to a water heater, together with the connecting part 174, hot water will flow around the connecting part 174 during operation. The connecting part 174 is therefore suitably designed to avoid the pipe connected thereto from relaxing and disconnecting during operation. By way of example, a sleeve 176 may slide over a tube 1200 (shown in FIG. 4) that is subsequently crimped to ensure a suitable connection between the connecting part 174 and tube 1200.

With the above in mind, it will be appreciated that the connecting part 174 forms a fitting that slides into relatively easy engagement with a tube. That is, pushing is primarily required to make a connection with the tube. These fittings assist in eliminating the need for certain laborious steps when connecting a fluid conduit to a plumbing fitting. For example, using a this type of fitting generally eliminates the need for soldering when connecting a conduit to a fitting. These fittings are advantageous in general because the fittings: a) do not have to be soldered to copper conduits or glued to plastic conduits; b) can quickly and easily be mounted and in some embodiment unmounted and re-used; and c) are, in many embodiments, easily rotated after a conduit and fitting are connected. Further, these types of fittings, unlike fittings that must be soldered or glued, can be used when wet.

The adjusting portion 200 includes a cap 210, a connecting member 220, an adjusting member 230, a spring 240 and a stop 250. The cap 210 is configured to cover, amongst other things, the connecting member 220 and the adjusting member 230. The cap 210 is typically plastic and, in this embodiment, is connected to the adjusting member 230. The connecting member 220 is configured to attach to the connecting aperture 150 of the valve body 110. The connecting member 220 includes an extrusion 222 that assist in limiting the rotation of the adjusting member 230 by providing a stop that interacts with at least a part connected to the adjusting member 230.

The adjusting member 230 includes a housing 232. The housing 232 is substantially circular and includes an aperture partway therethrough. The housing 232 is configured to be connected to the connecting member 220. In particular, the housing 232 is fastened to the connecting member 220 such that rotation of the housing 232 moves the housing 232 along the axis 12. That is, the housing 232 translates relative to the body 100 upon rotation thereof. To move the housing 232, a tool is engaged with a driving portion 234 of the housing 232. The driving portion 234 forms an aperture in the housing 232. As the tool is rotated, the housing 232 moves away or towards the thermostatic element 400. The housing 232 may also be rotated by rotating the cap 210. With this in mind, the housing 232 houses the spring 240 and the stop 250. The spring 240 biases the stop 250 towards an end of the housing 232 (closest to the thermostatic element 400). A circlip assists in retaining the stop 250 in the housing 232. The stop 250 is configured to interact with the thermostatic element 400 such that it resists movement of part of the thermostatic element 400. As outlined further below, the interaction between the stop 250 and the thermostatic element 400 assists in establishing a predetermined water outlet temperature for the valve 10.

The piston 300 is substantially circular in this embodiment. The piston 300 is supported by the thermostatic element 400. On this basis, as the thermostatic element 400 moves, through its interaction with the stop 250, the piston 300 also moves. The piston 300 is therefore configured to move between a first seat and a second seat associated with the body 100. Movement between the seats controls the quantities of hot and cold water passing thereby, towards the outlet aperture 140, to achieve the predetermined outlet temperature. The first and second channels 134, 136 encircle the piston 300 at respective opposite ends. A seal on the valve body 110 seals against the piston 300 in order to fluidly separate the first channel 134 from the second channel 136, adjacent the end portions of the piston 300.

The thermostatic element 400 is supported by the supporting member 500. The supporting member 500 is substantially hollow but includes one or more parts that extend to support the thermostatic element 400 along the axis 12. The supporting member 500 rests on a return spring 600. In a similar manner to the (overtravel) spring 240, the return spring is a helical spring. The return spring 600 rests on part of the valve body 110 in order to bias the supporting member 500, along with the thermostatic element 400 and piston 300, towards the stop 250.

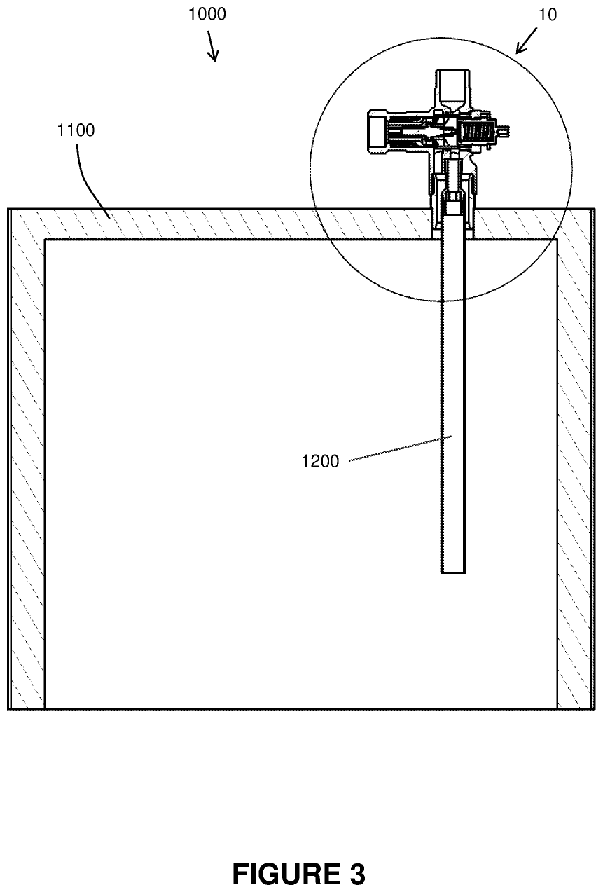

As shown in FIGS. 3 and 4, the valve 10 is connected to a water system 1000 during use. In particular, a tube 1200 associated with the tank 1100 is connected to the connecting part 174. The tube 1200 may be in the form of a polymer pipe. The barbed nature of the connecting part 174 in this embodiment, along with any other like fitting (e.g., screw, push-to-connect etc), allows easy connection of the tube 1200 to the connecting part 174. The crimped sleeve 176 assists in ensuring a secure connection between the tube 1200 and connecting part 174. The tube 1200 assists in delivering cold water to the tank 1100 as it is in fluid communication with the first aperture 120 via the first channel 134. By providing the connecting part 174 with the tube 1200, a clearly separate path is created for the cold water into the tank.

The valve 10 is connected to the tank 1100 by fastening the tank connecting portion 164 to the tank 1100. As will be appreciated, the tube 1200 would first be connected to the connecting fitting 170 and crimped with sleeve 176. Following this, the adapter 160 would be fastened to the body 100, via body connecting portion 162, and then subsequently fitted to the tank 1100 with the connecting portion 164. In further embodiments, it would be understood that the valve 10 may be fastened to other portions of the water heating system 1000 in order to put the valve 10 in fluid communication therewith.

With the valve 10 connected to the tank 1100, the predetermined outlet temperature of the valve 10 may be set. In particular, the driving portion 234 is rotated to a predetermined position that sets an initial distance between the stop 250 and a part of the thermostatic element 400. The moving interaction between the stop 250 and at least part of the thermostatic element 400 shifts the piston 300 to regulate the flow of hot/cold fluid past the piston 300 in order to achieve the predetermined outlet temperature. That is, to further elaborate, as a user draws water downstream from the outlet aperture 140, hot water is drawn from the tank 1100 along the second channel 136 and cold water is drawn along the first channel 134. Part of the cold water and the hot water pass the ends of the piston 300 and begin to mix over the thermostatic element 400. In response to thermostatic element 400 being exposed to the mixed water, a part of the thermostatic element 400 adjusts (i.e., a piston/needle), based on the temperature to interact with the stop 250. This interaction adjusts the position of the piston 300 in order to achieve the predetermined outlet temperature.

With the above in mind, as cold water is drawn through the first channel 134, part of the cold water is channelled through the connection fitting 170 and into the tank 1100 (via the tube 1200). This allows the cold water to enter the tank 1100 in order to be heated.

The valve 10 provides a relatively simple arrangement to incorporate: i) a thermostatic valve into a hot water system; and ii) a cold water tank inlet into a thermostatic element. The linear arrangement between the first aperture 120, the second aperture 130 and channels 134, 136, along with the dividing portion 132 and connection fitting 170, provide a relative simple construction to manufacture and assemble. Furthermore, by having largely direct flow paths, and avoiding channels with bends, the pressure drop across the valve 10 may also be assisted. In addition, the connection fitting 170 allows a tube 1200 to be readily connected thereto for ease of assembly with the tank 1100.

In this specification, adjectives such as left and right, top and bottom, hot and cold, first and second, and the like may be used to distinguish one element or action from another element or action without necessarily requiring or implying any actual such relationship or order. Where context permits, reference to a component, an integer or step (or the alike) is not to be construed as being limited to only one of that component, integer, or step, but rather could be one or more of that component, integer or step.

The above description relating to embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art from the above teaching. Accordingly, while some alternative embodiments have been discussed specifically, other embodiments will be apparent or relatively easily developed by those of ordinary skill in the art. The invention is intended to embrace all modifications, alternatives, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Item List:

| Item No | Item |
|---|---|
| 10 | Valve |
| 12 | Axis |
| 100 | Body |
| 110 | Valve Body |
| 120 | First Aperture |
| 130 | Second Aperture |
| 132 | Dividing Portion |
| 134 | First Channel |
| 136 | Second Channel |
| 138 | Connecting Portion |
| 139 | Fastening Portion |
| 140 | Outlet Aperture |
| 150 | Connecting Aperture |
| 160 | Adapter |
| 162 | Body Connecting Portion |
| 164 | Tank Connecting Portion |
| 170 | Connection Fitting |
| 172 | Attaching Part |
| 174 | Connecting Part |
| 176 | Sleeve |
| 200 | Adjusting Portion |
| 210 | Cap |
| 220 | Connecting Member |
| 222 | Extrusion |
| 230 | Adjusting Member |
| 232 | Housing |
| 234 | Driving Portion |
| 240 | Spring |
| 250 | Stop |
| 300 | Piston |
| 400 | Thermostatic Element |
| 500 | Supporting Member |
| 600 | Return Spring |
| 1000 | Water Heater |
| 1100 | Tank |
| 1200 | Tube |

1. A valve including:
a body having:
a first aperture;
a second aperture;
a first channel in fluid communication with the first aperture;
a second channel in fluid communication with at least part of the second aperture; and
an outlet aperture; and
an adjusting portion associated with the body, the adjusting portion providing a stop;
a piston in fluid communication with the first channel, the second channel and the outlet aperture;
a thermostatic element configured to assist with moving the piston in response to engaging with the stop, the piston being configured to regulate fluid flow from the first channel and the second channel to the outlet aperture; and
a return spring configured to assist with biasing the thermostatic element, wherein part of the fluid flow entering the first channel flows along the piston and exits from a portion of the second aperture.

2. The valve of claim 1, wherein a connection fitting is connected to the first channel, the connection fitting being configured to connect to a tube.

3. The valve of claim 2, wherein the connection fitting is configured to connect to the tube by sliding the tube into engagement with the connection fitting.

4. The valve of claim 3, wherein the connection fitting includes one or more barbs.

5. The valve of claim 2, wherein the connection fitting is configured to maintain a connection with the tube whilst hot water passes thereover.

6. The valve of claim 2, wherein at least part of the connection fitting is surrounded by part of the body.

7. The valve of claim 2, wherein the connection fitting includes a connecting part that is configured to threadingly connect to a connecting portion that is formed in the first channel.

8. The valve of claim 2, wherein the body includes an adapter that is configured to connect to a water heater.

9. The valve of claim 8, wherein at least part of the connection fitting is surrounded by part of the adapter.

10. The valve of claim 1, wherein a cap covers at least part of the body.

11. The valve of claim 1, wherein the adjusting portion includes an aperture to receive a driving tool to adjust the position of the stop.

12. A method of controlling fluid flow through a valve for a water heater, the method including:
flowing fluid through a first aperture;
flowing fluid through at least part of a second aperture; and
adjusting a piston such that fluid from the first aperture and the second aperture is mixed in a way to reach a predetermined temperature as it exits an outlet aperture, wherein part of the fluid entering the first aperture is directed to flow in contact around the piston in order to be directed out of a portion of the second aperture.

13. The method of claim 12, wherein the method further includes connecting a connection fitting to a tube, the connection fitting being in fluid communication with the first aperture.

14. The method of claim 13, wherein the step of connecting the connection fitting to the tube includes pushing the tube into connection with the connection fitting.

15. The method of claim 14, wherein the step of pushing the tube into connection with the connection fitting includes moving the tube over one or more barbs.

16. The method of claim 13, wherein the step of directing fluid flow out of the portion of the second aperture includes flowing the fluid along the connection fitting.

17. The method of claim 12, wherein the method further includes connecting an adapter to the water heater.

18. A kit including:
a body having:
a first aperture;
a second aperture;
a first channel in fluid communication with the first aperture;
a second channel in fluid communication with at least part of the second aperture; and
an outlet aperture, wherein part of the fluid flow entering the first channel flows along a piston and exits from a portion of the second aperture; and
at least one of:
an adjusting portion associated with the body, the adjusting portion providing a stop;
the piston in fluid communication with the first channel, the second channel and the outlet aperture;
a thermostatic element configured to assist with moving the piston in response to engaging with the stop, the piston being configured to regulate fluid flow from the first channel and the second channel to the outlet aperture; or
a return spring configured to assist with biasing the thermostatic element.

19. The kit of claim 18, wherein a connection fitting is connected to the first channel, the connection fitting being configured to connect to a tube by sliding the tube into engagement with the connection fitting.

20. The kit of claim 19, wherein the body includes an adapter that is configured to connect to a water heater.
